(19) United States
(12) Patent Application Publication
(10) Pub. No.: US 2016/0053516 A1
(43) Pub. Date: Feb. 25, 2016

(54) LATCHING SYSTEM FOR A VEHICLE FLAP

(71) Applicant: AUDI AG, Ingolstadt (DE)

(72) Inventors: Marion Schoch, Neckarsulm (DE); Jean-Bernard Le Griffon, Offenau (DE)

(73) Assignee: AUDI AG, Ingolstadt (DE)

(21) Appl. No.: 14/831,500

(22) Filed: Aug. 20, 2015

(30) Foreign Application Priority Data
Aug. 21, 2014 (DE) 10 2014 012 466.5

(51) Int. Cl. E05B 77/10; E05B 85/22

(52) U.S. Cl. CPC E05B 77/10; E05B 85/22

(57) ABSTRACT

A latching system includes a closing wedge module with two closing wedges supported for movement relative to one another and having wedge faces, and a closing wedge holder for movably receiving the closing wedges. A holding jaw module has two holding jaws to receive the closing wedge module there between. The holding jaws have keyways configured to complement a contour of the wedge faces of the closing wedges. A drive unit moves the closing wedges apart to thereby push the wedge faces into the keyways of the holding jaws and to couple a vehicle flap with a structural part of a vehicle body. At least one of the closing wedges has a predetermined breaking point to separate into a keyway-proximal part and a closing-wedge-holder-proximal part, when the closing wedge is pushed into the keyways and a stress resistance of the closing wedge is exceeded by a mechanical load during operation.

### CROSS-REFERENCES TO RELATED APPLICATIONS

This application claims the priority of German Patent Application, Serial No. 10 2014 012 466.5, filed Aug. 21, 2014, pursuant to 35 U.S.C. 119(a)-(d), the disclosure of which is incorporated herein by reference in its entirety as if fully set forth herein.

### BACKGROUND OF THE INVENTION

The present invention relates to a latching system for releasably connecting a vehicle flap, e.g. a vehicle door, to a vehicle structural part, e.g. a side-panel frame of a vehicle body. The term “vehicle flap” is used here in a generic sense and may involve any pivotably mounted body part. Other examples of a vehicle flap include a tailgate, trunk lid, hatchback, or hood.

The following discussion of related art is provided to assist the reader in understanding the advantages of the invention, and is not to be construed as an admission that this related art is prior art to this invention.

In vehicles involved in an accident, e.g. a crash with another vehicle, there is the possibility that the vehicle flap, e.g. vehicle door, and the body structure become twisted to such an extent that the latching system renders an opening difficult or even impossible.

It would therefore be desirable and advantageous to provide an improved latching system to obviate prior art shortcomings and to allow opening of a vehicle flap even after an accident of the vehicle.

### SUMMARY OF THE INVENTION

According to one aspect of the present invention, a latching system for releasably coupling a vehicle flap with a structural part of a vehicle body comprises a closing wedge module including two closing wedges supported for movement in relation to one another and having wedge faces, and a closing wedge holder for movably receiving the closing wedges, a holding jaw module including two holding jaws to receive the closing wedge module there between, the holding jaws having keyways configured to complement a contour of the wedge faces of the closing wedges, and a drive unit configured to move the closing wedges apart to thereby push the wedge faces into the keyways of the holding jaws and couple the vehicle flap with the structural part, at least one of the closing wedges having a predetermined breaking point to separate into a keyway-proximal part and a closing-wedge-holder-proximal part, when the at least one of the closing wedges is pushed into the keyways and a stress resistance of the at least one of the closing wedges is exceeded by a mechanical load during operation.

The present invention resolves prior art problems by providing a precisely defined weakening of the closing wedge of the latching system which weakening is so configured that, on one hand, the vehicle flap, e.g. a vehicle door, is securely wedged in the structure of the vehicle body, when subjected to an accident, e.g. a head-on collision, and yet can be opened after the collision, and, on the other hand, any mechanical stress to which the latching system may be exposed during normal operation is prevented from causing a breakage of the closing wedge.

The localized weakening of at least one closing wedge as a result of the presence of a predetermined breaking point causes a breakage in the region of the predetermined breaking point, when a specific force threshold has been reached. As a consequence, the connection between the closing wedge and the holding jaws, receiving the closing wedge, is severed because the closing wedge is separated into a keyway-proximal part and a closing-wedge-holder-proximal part. Hence, also the connection of the vehicle flap, e.g. vehicle door, is separated from the structure of the vehicle body.

According to another advantageous feature of the present invention, the predetermined breaking point is arranged between a region of the at least one of the closing wedges that is received by the closing wedge holder, and the wedge faces of the at least one of the closing wedges. As a result, the predetermined breaking point can be arranged in immediate proximity of the closing wedge holder so that at the same time a shearing effect is realized in the event of a crash.

According to another advantageous feature of the present invention, the predetermined breaking point can be configured as a cross sectional constriction of the at least one of the closing wedges. Advantageously, the constriction may have a rectangular cross section, or a concave curvature, or a conical configuration.

As an alternative to a geometric configuration, the predetermined breaking point may also be realized by appropriately configuring a material of the at least one of the closing wedges. Metallic materials can be configured in various ways, e.g. hardening or soft annealing to adjust ductility. Advantageously, the region of the predetermined breaking point can be formed from a material having a ductility which is higher than a ductility of a material outside of the region of the predetermined breaking point. In this way, the region of the predetermined breaking point with higher ductility ruptures when the predefined load force acting on ₜhe latching system has been reached.

According to another advantageous feature of the present invention, the closing wedge holder can be spaced from an adjacent structure of the holding jaw module by a gap which extends in perpendicular relation to a movement direction of the closing wedges, when being pushed into the keyways of the holding jaw module to couple the latching system, and in perpendicular relation to a profile of the keyways. This ensures that the closing wedge holder is unable to find support on the holding jaw module, when the specific load force has been reached; otherwise a breakage of the predetermined breaking point would be prevented.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic exploded view of a latching system in accordance with the present invention for use in a vehicle;

FIG. 2 a schematic sectional view of the latching system of FIG. 1, depicting a closing wedge module and a holding jaw module in a state in which, by way of example, a vehicle door is coupled with a side-panel frame of a vehicle body; and

FIG. 3 a schematic sectional view of the latching system of FIG. 2, depicting the closing wedge module with fractured closing wedges.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

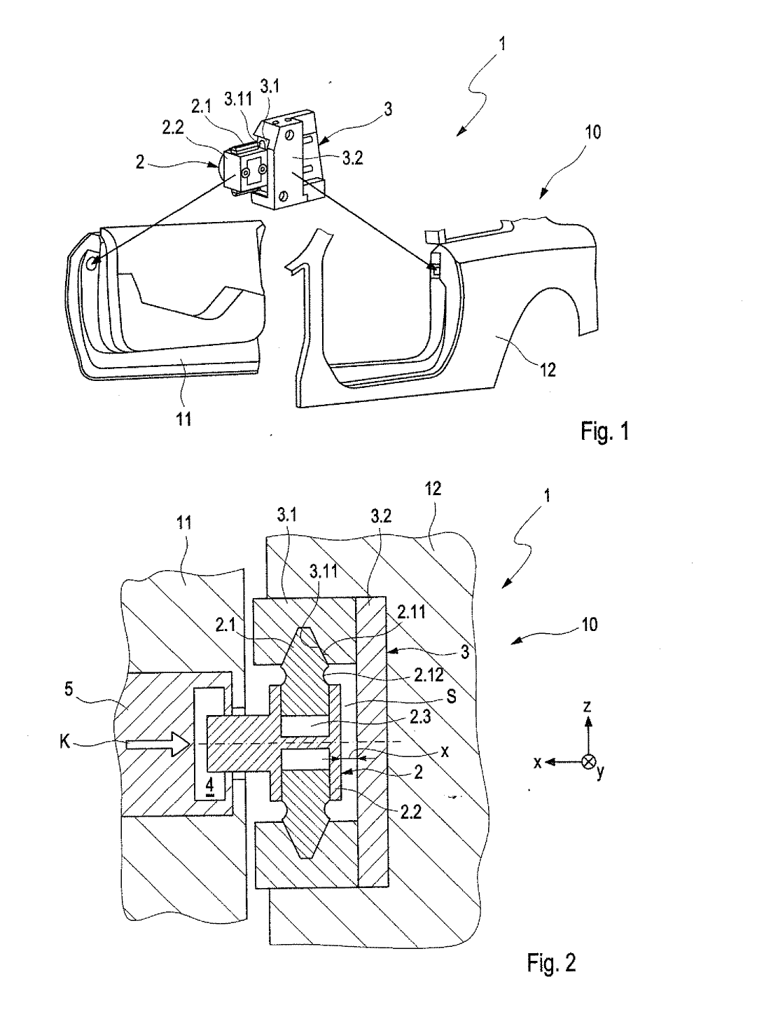

Turning now to the drawing, and in particular to FIG. 1, there is shown a schematic exploded view of a latching system according to the present invention, generally designated by reference numeral 1, for use in a vehicle. By way of example, the latching system 1 is shown here in its function as a door lock for a vehicle door 11 of a vehicle body 10. The latching system 1 has a closing wedge module, generally designated by reference numeral 2, and a holding jaw module, generally designated by reference numeral 3. The closing wedge module 2 is mounted as lock onto the vehicle door 11, and the holding jaw module 3 is mounted to a door frame formed by a side-panel frame 12 of the vehicle body 10. When the vehicle door 11 is closed, the closing wedge module 2 is coupled with the holding jaw module 3 so as to establish a force-locking connection between the vehicle door 11 and the side-panel frame 12 of the vehicle body 10. A specific construction and manner in which a latching system of the type involved here can be operatively and functionally incorporated into a vehicle door is fully described in commonly assigned German patent application DE 10 2012 011 420 A1, the entire specification and drawings of which are expressly incorporated herein by reference.

FIG. 2 is a schematic sectional view of the latching system 11, depicting a state in which the closing wedge module 2 is coupled with the holding jaw module 3, i.e. the vehicle door is closed. The closing wedge module 2 of the latching system 1 is mechanically connected by a coupling element 5 to the vehicle door 11. The holding jaw module 3 is mechanically coupled via the side-panel frame 12 to the vehicle body 10.

The closing wedge module 2 includes a closing wedge holder 2.2 for receiving two closing wedges 2.1, supported for movement in closing wedge holder grooves 2.3, respectively, and configured at their ends with wedge faces 2.11 of conical shape. A driving device 4, indicated only schematically, moves both closing wedges 2.1 in opposite directions from a retracted position in which the closing wedges 2.1 have completely moved into the closing wedge holder grooves 2.3, to a closing position in which the closing wedges 2.1 are pushed with their terminal wedge faces 2.11 into keyways 3.11, respectively, of the holding jaw module 3, with the keyways 3.11 being configured to complement the contour of the wedge faces 2.11. As a result, a force-locking connection is established between the vehicle door 11 and the side-panel frame 12 in both z direction and x direction. The keyways 3.11 are respectively configured in holding jaws 3.1 which together with a base plate 3.2 form the holding jaw module 3.

To prevent the latching system 1 from jamming between the vehicle door 11 and the body structure in the event of a crash, e.g. a head-on collision, such that opening of the vehicle door becomes difficult or even impossible after the crash, at least one of the closing wedges 2.1, here both closing wedges 2.1, of the closing wedge module 2, are each formed with a predetermined breaking point 2.12. According to FIG. 2, the predetermined breaking point 2.12 is realized as a cross sectional constriction of concave curvature. The predetermined breaking point 2.12 is located in a region outside of the closing wedge holder 2.2, i.e. between the region of the closing wedge holder 2.2 and the keyways 2.11. According to FIG. 2, the predetermined breaking point 2.12 is immediately adjacent to the closing wedge holder 2.2.

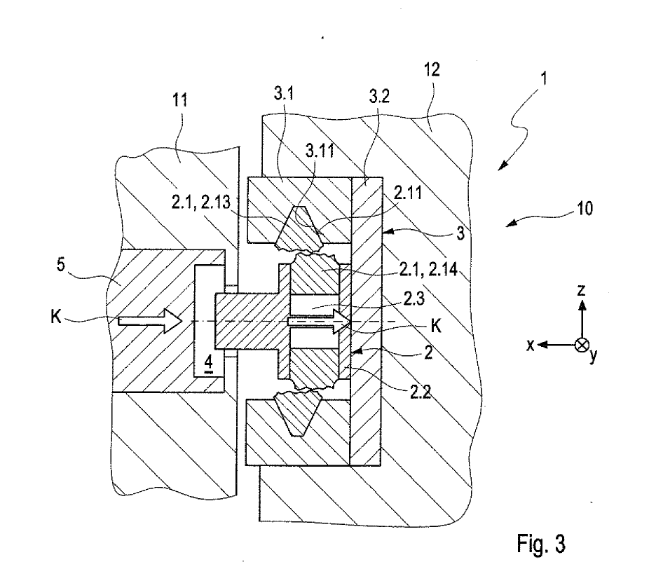

The predetermined breaking point 2.12 is provided to rupture when a head-on collision causes a force introduction in vehicle longitudinal direction (x direction) at a force K which exceeds the normal stress resistance of the latching system 1 during operation, i.e. the force K is greater than the load force normally encountered during operation. As the predetermined breaking point 2.12 ruptures, the closing wedge 2,1 is split into a keyway-proximal part 2.13 and a closing-wedge-holder-proximal part 2.14, as shown schematically in FIG. 3. As both closing wedges 2.1 rupture, a gap S between the closing wedge holder 2.2 and the base plate 3.2 of the holding jaw module 3 with a gap measure x is bridged so that the closing wedge holder 2.2 bears upon the base plate 3.2 and become locked to one another. As a result, the connection between the closing wedge module 2 and the holding jaw module 3 is severed so that the vehicle door 11 is no longer connected with the side-panel frame 12 of the vehicle body 10. The vehicle door 11 can therefore be opened.

The predetermined breaking point 2.12 of the closing wedges 2.1 may be configured as an area of material weakening in various ways. As described above in FIG. 2, the predetermined breaking point 2.12 may be realized as a cross sectional constriction of the closing wedge 2.1 with a concave depression or groove or notch. Instead of a concave depression, the predetermined breaking point 2.12 may also be realized as rectangular groove. Also combinations of different shapes or curvatures of such depressions may be used as predetermined breaking point 2.12. The extent of the material weakening realized by the predetermined breaking point 2.12 is selected such that mechanical stress normally encountered during operation does not cause a rupture of the closing wedges 2.1, The predetermined breaking point 2.12 ruptures only when the force introduction reaches a specific force threshold as a result of a crash.

Instead of a geometric shape of the predetermined breaking point, this region may also be realized by appropriately configuring the material in this region. The region of the predetermined breaking point 2.12 may, for example, be formed from a material which has a ductility which is higher than the ductility of the harder material outside of the area of the predetermined breaking point 2.12. As a result, the region representing the predetermined breaking point 2.12 and having higher ductility ruptures, when the specific loading force K that acts upon the latching system 1 and exceeds the normal load during operation, has been reached.

In the afore-described exemplary embodiment, the closing wedge module 2 is mounted to the vehicle door 11 and the holding jaw module 3 is mounted to the side-panel frame 12 or B column of the vehicle body 10. Of course, the latching system 1 may also be mounted the other way so that the holding jaw module 3 is mounted to the vehicle door 11 and the closing wedge module 2 is mounted to the side-panel frame 12 or B column of the vehicle body 10.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A latching system for releasably coupling a vehicle flap with a structural part of a vehicle body, comprising:
a closing wedge module including two closing wedges supported for movement in relation to one another and having wedge faces, and a closing wedge holder for movably receiving the closing wedges;
a holding jaw module including two holding jaws to receive the closing wedge module there between, said holding jaws having keyways configured to complement a contour of the wedge faces of the closing wedges; and
a drive unit configured to move the closing wedges apart to thereby push the wedge faces into the keyways of the holding jaws and couple the vehicle flap with the structural part,
at least one of the closing wedges having a predetermined breaking point to separate into a keyway-proximal part and a closing-wedge-holder-proximal part, when the at least one of the closing wedges is pushed into the keyways and a stress resistance of the at least one of the closing wedges is exceeded by a mechanical load during operation.

2. The latching system of claim 1, wherein the at least one of the closing wedges has a region which is received by the closing wedge holder, said predetermined breaking point being arranged between the region of the at least one of the closing wedges and the wedge faces thereof.

3. The latching system of claim 1, wherein the predetermined breaking point is configured as a cross sectional constriction of the at least one of the closing wedges.

4. The latching system of claim 1, wherein the constriction has a rectangular cross section.

5. The latching system of claim 1, wherein the constriction has a concave curvature.

6. The latching system of claim 1, wherein the constriction has a conical configuration.

7. The latching system of claim 1, wherein the predetermined breaking point is formed by configuring a material of the at least one of the closing wedges.

8. The latching system of claim 7, wherein the predetermined breaking point defines a region which is formed from a material having a ductility which is higher than a ductility of a material outside of the region of the predetermined breaking point.

9. The latching system of claim 1, wherein the closing wedge holder is spaced from an adjacent structure of the holding jaw module by a gap which extends in perpendicular relation to a movement direction of the closing wedges, when being pushed into the keyways of the holding jaw module in a coupled state of the latching system, and in perpendicular relation to a profile of the keyways.

10. The latching system of claim 1, for a vehicle door as vehicle flap for coupling with a side-panel frame as structural part of the vehicle body.
